(19) United States
(12) Patent Application Publication
(10) Pub. No.: US 2022/0214034 A1
(43) Pub. Date: Jul. 7, 2022

(54) LED LIGHTED BEAUTY FRIDGE WITH A MIRROR

(71) Applicant: Shenzhen Sanjutou Network Technology Co., Ltd., Shenzhen (CN)

(72) Inventor: Zhihao YAO, Shenzhen (CN)

(21) Appl. No.: 17/141,784

(22) Filed: Jan. 5, 2021

(51) Int. Cl. F21V 33/00; F21V 23/04; F25D 23/02; F25D 27/00; A47B 67/00; A47B 67/02

(52) U.S. Cl. CPC F21V 33/004; F21V 23/0485; F25D 23/028; F21Y 2115/10; A47B 67/005; A47B 67/02; F25D 27/00

(57) ABSTRACT

The present utility model is related to the technical field of skincare, in particular, it refers to a LED lighted beauty fridge with a mirror, which can store skincare products and also increase the convenience of the customer; it includes the fridge body and its respective door, the fridge door has a pivot hinge on the front which connects to the body of the fridge, the fridge door has a mirror and a control circuit, the mirror is embedded with LED light strips; the mirror has a touch switch button, and the LED light strips are electrically connected to the touch switch button through the control circuit.

### TECHNICAL FIELD

The present utility model is related to the technical field of skincare, in particular, it refers to a LED lighted beauty fridge with a mirror.

### BACKGROUND TECHNIQUE

In the current context, where more and more people are using skincare products, there is a high demand for application technologies to maintain skincare products cooler and fresher for longer periods.

The beauty fridges you see on the market today only have simple storage and cooling functions and are not suitable for application scenarios. Developing a kind of beauty fridge with mirror and lights can solve the current problem that the beauty fridge is not convenient to use under application scenarios; the existing products have the following disadvantages: 1. The beauty fridge will produce condensed water during the process of use, it is necessary to clean the condensation; 2. The door of the beauty fridge has a pure mirror design, and the mirror is easy to scratch and break.

Utility Model Content

To solve the above technical problems, the present utility model features a LED lighted beauty fridge with a mirror, it can store skincare products and increase the convenience of the customer.

The present utility model of the LED lighted beauty fridge with a mirror includes the fridge body and its respective door, the fridge door has a pivot hinge on the front which connects to the body of the fridge, the fridge door has a mirror and a control circuit, the mirror is embedded with LED light strips; the mirror has a touch switch button, and the LED light strips are electrically connected to the touch switch button through the control circuit.

The present utility model of the LED lighted beauty fridge with a mirror, the four corners of the mirror are rounded.

The present utility model of the LED lighted beauty fridge with a mirror, the LED light strips have a rounded structure.

The present utility model of the LED lighted beauty fridge with a mirror, the upper part of the body of the fridge equips a handle.

The present utility model of the LED lighted beauty fridge with a mirror, one end of the fridge door equips a second handle.

In comparison with current techniques, the advantages of the new utility model are: The mirror is designed in the door of the beauty fridge, the LED light strips and the light strip switch are placed on it, which serves as a makeup mirror and a fill light. During use, the beauty fridge is designed with a mirror and LED lights, which allows it to use the functions of storage and cooling, while also maximizing the makeup application scenarios.

### DESCRIPTION OF THE DRAWINGS

FIG. 1 is a structural representation stereogram of the present utility model

FIG. 2 is an internal construction schematic diagram of the present utility model.

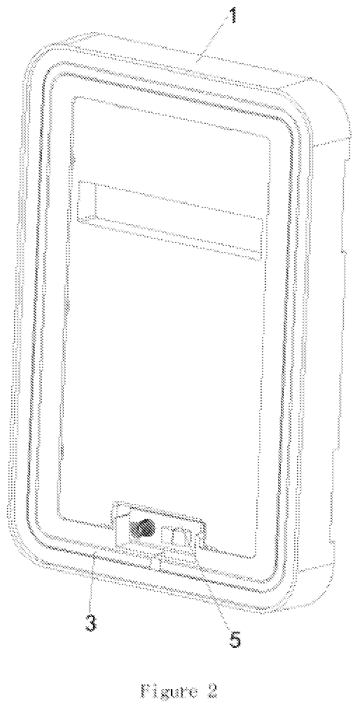

FIG. 3 is a structural representation stereogram of the second handle of the present utility model.

Marks of figures: 1. Fridge door; 2. Mirror; 3. LED light strip; 4. LED touch switch; 5. Control circuit; 6. Fridge body; 7. First handle; 8. Second handle.

### EMBODIMENT

Below in conjunction with the accompanying drawings and embodiment, a detailed description of the invention of the present utility model is described in further detail. Below embodiment is used for illustrating this utility model but is not limited to scope of the present utility model.

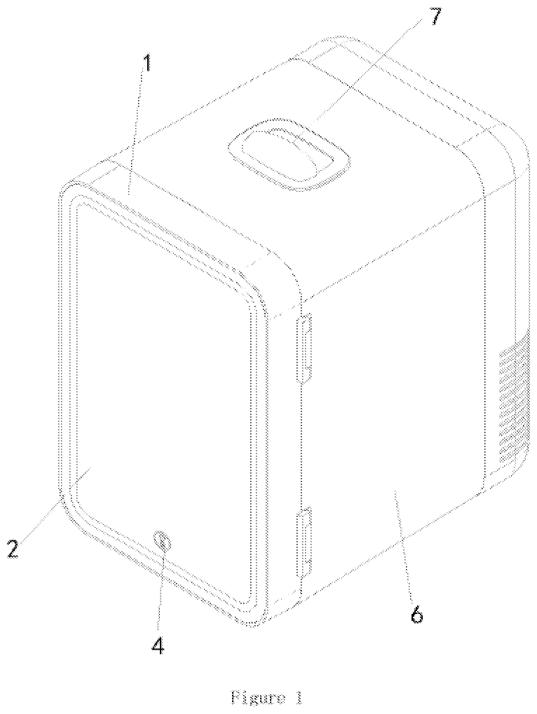

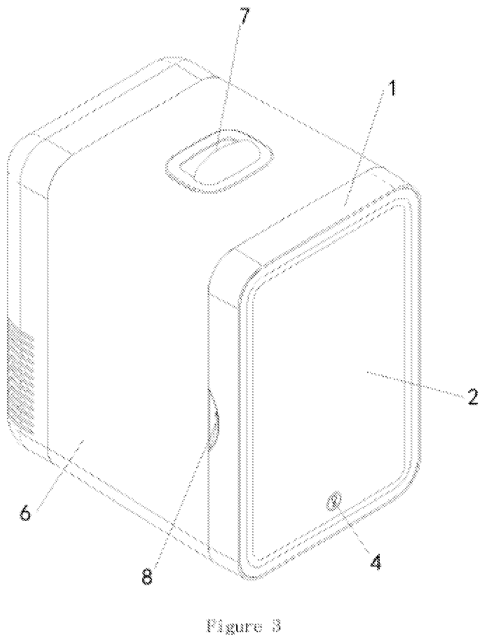

As shown in FIGS. 1 and 3, the present utility model of the LED lighted beauty fridge with a mirror includes the fridge body 6 and its respective door 1, the fridge door 1 has a pivot hinge on the front which connects to the body of the fridge 6, the fridge door has a mirror 2 and a control circuit 5, the mirror 2 is embedded with LED light strips 3; the mirror 2 has a touch switch button 4, and the LED light strips 3 are electrically connected to the touch switch button 4 through the control circuit 5.

The present utility model of the LED lighted beauty fridge with a mirror, the four corners of the mirror 2 are rounded.

The present utility model of the LED lighted beauty fridge with a mirror, the LED light strips 3 have a rounded structure.

The present utility model of the LED lighted beauty fridge with a mirror, the upper part of the body of the fridge 6 equips a handle 7.

The present utility model of the LED lighted beauty fridge with a mirror, one end of the fridge door 1 equips a second handle 8.

The present utility model of the LED lighted beauty fridge with a mirror, the mirror is designed in the door of the beauty fridge, the LED light strips and the light strip switch are placed on it, which serves as a makeup mirror and a fill light. During use, the beauty fridge is designed with a mirror and LED lights, which allows it to use the functions of storage and cooling, while also maximizing the makeup application scenarios.

The above embodiment is only a preferred method of the embodiment of the present utility model and should be understood that the utility model for those skilled in the art, under the prerequisite that does not break away from the utility model know-why, can also make some improvements and modifications, these improvements and modifications also should be considered as protection domain of the present utility model.

What is claimed is:

1. A Light Emitting Diode (LED) lighted beauty fridge with a mirror, comprising:
a fridge body (6);
a fridge door (1), the fridge door (1) has a pivot hinge on the front to connect to the fridge body (6), the fridge door has:
a mirror (2), and
a control circuit (5),
wherein the mirror (2) is embedded with a seamless LED light strip (3) across a circumference of the mirror such that the mirror is concentric to the seamless LED light strip (3);
the mirror (2) has a touch switch button (4), and the LED light strips (3) are electrically connected to the touch switch button (4) through the control circuit (5).

2. The LED lighted beauty fridge with the mirror as claimed in claim 1, wherein the mirror (2) comprises four rounded corners.

3. The LED lighted beauty fridge with the mirror as claimed in claim 2, wherein the LED light strips (3) comprises a rounded structure.

4. The LED lighted beauty fridge with the mirror as claimed in claim 3, wherein the fridge body (6) comprises a handle (7) along an upper part of the fridge body (6).

5. The LED lighted beauty fridge with the mirror as claimed in claim 4, wherein the fridge door (1) further comprises a second handle (8) along one end thereof.
